(19) United States
(12) Patent Application Publication
(10) Pub. No.: US 2019/0366773 A1
(43) Pub. Date: Dec. 5, 2019

(54) TREAD FOR A PNEUMATIC TIRE

(71) Applicant: The Goodyear Tire & Rubber Company, Akron, OH (US)

(72) Inventor: Julien Alexandre VAISSAUD, Arlon (BE)

(21) Appl. No.: 15/992,233

(22) Filed: May 30, 2018

(51) Int. Cl. B60C 11/03

(52) U.S. Cl. CPC B60C 11/032

(57) ABSTRACT

A first tread for a tire includes a first circumferential groove axially separating a circumferential first rib and a second circumferential rib, a first outer surface of the first rib having at least one circumferential column of circumferential, double blind perforations extending linearly fully around the first outer surface of the first rib.

### FIELD OF INVENTION

The present invention relates to a pneumatic tire with an improved tread, and more particularly, relates to a pneumatic tire tread having improved acoustic characteristics.

### BACKGROUND OF THE INVENTION

Conventionally, in addition to circumferential main grooves and lateral grooves, pneumatic tire treads may have longitudinal/lateral sipes on a tread surface in order to demonstrate favorable functional characteristics (e.g., low rolling resistance, good traction, good durability, etc.).

### Definitions

The following definitions are controlling for the disclosed invention.

“Axial” and “Axially” means the lines or directions that are parallel to the axis of rotation of the tire.

“Axially Inward” means in an axial direction toward the equatorial plane.

“Axially Outward” means in an axial direction away from the equatorial plane.

“Bead” or “Bead Core” generally means that part of the tire comprising an annular tensile member of radially inner beads that are associated with holding the tire to the rim.

“Belt Structures” or “Reinforcement Belts” or “Belt Package” means at least two annular layers or plies of parallel cords, woven or unwoven, underlying the tread, unanchored to the bead, and having both left and right cord angles in the range from 18 degrees to 30 degrees relative to the equatorial plane of the tire.

“Carcass” means the tire structure apart from the belt structure, tread, undertread over the plies, but including the beads.

“Circumferential” means circular lines or directions extending along the perimeter of the surface of the annular tread perpendicular to the axial direction; it can also refer to the direction of the sets of adjacent circular curves whose radii define the axial curvature of the tread, as viewed in cross section.

“dBA” means A-weighted decibels, abbreviated dBA, or dBa, or dB(a), which are an expression of the relative loudness of sounds in air as perceived by the human ear. In the A-weighted system, the decibel of sounds at low frequencies are reduced, compared with unweighted decibels, in which no correction is made for audio frequency. This correction is made because the human ear is less sensitive at low audio frequencies, especially below 1000 hertz, than at high audio frequencies.

“Directional Tread Pattern” means a tread pattern designed for specific direction of rotation.

“Equatorial Plane” means the plane perpendicular to the tire's axis of rotation and passing through the center of its tread; or the plane containing the circumferential centerline of the tread.

“Footprint” means the contact patch or area of contact of the tire tread with a flat surface under normal load pressure and speed conditions.

“Groove” means an elongated void area in a tread that may extend circumferentially or laterally in the tread in a straight, curved or zigzag manner. It is understood that all groove widths are measured perpendicular to the centerline of the groove.

“Hertz” means number of cycles per second.

“Lateral” means a direction going from one sidewall of the tire towards the other sidewall of the tire.

“Net to gross” means the ratio of the net ground contacting tread surface to the gross area of the tread including the ground contacting tread surface and void spaces comprising grooves, notches and sipes.

“Notch” means a void area of limited length that may be used to modify the variation of net to gross void area at the edges of blocks.

“Ply” means a cord-reinforced layer of rubber coated radially deployed or otherwise parallel cords.

“Radial” and “radially” mean directions radially toward or away from the axis of rotation of the tire.

“Radial Ply Tire” means a belted or circumferentially-restricted pneumatic tire in which at least one ply has cords which extend from bead to bead are laid at cord angles between 65 degrees and 90 degrees with respect to the equatorial plane of the tire.

“Shoulder” means the upper portion of sidewall just below the tread edge.

“Sidewall” means that portion of a tire between the tread and the bead.

“Sipe” means a groove having a width in the range of 0.2 percent to 0.8 percent of the tread width. Sipes are typically formed by steel blades having a 0.4 to 1.6 mm, inserted into a cast or machined mold.

“Tangential” and “Tangentially” refer to segments of circular curves that intersect at a point through which can be drawn a single line that is mutually tangential to both circular segments.

“Tread” means the ground contacting portion of a tire.

“Tread width” (TW) means the greatest axial distance across the tread, when measured (using a footprint of a tire) laterally from shoulder to shoulder edge, when mounted on the design rim and subjected to a specified load and when inflated to a specified inflation pressure for said load.

“Void Space” means areas of the tread surface comprising grooves, notches and sipes.

### SUMMARY OF THE INVENTION

A first tread for a tire in accordance with the present invention includes a first circumferential groove axially separating a circumferential first rib and a second circumferential rib, a first outer surface of the first rib having at least one circumferential column of circumferential, double blind perforations extending linearly fully around the first outer surface of the first rib.

According to another aspect of the first tread, a second outer surface of the second rib has at least one circumferential column of circumferential, double blind perforations extending linearly fully around the second outer surface of the second rib.

According to still another aspect of the first tread, the first outer surface has between 2 and 12 circumferential columns of circumferential, double blind perforations extending linearly fully around the first outer surface of the first rib.

According to yet another aspect of the first tread, the second outer surface has between 2 and 12 circumferential columns of circumferential, double blind perforations extending linearly fully around the second outer surface of the second rib.

According to still another aspect of the first tread, the perforations of the first rib have a radial depth between 1.0 mm and 3.0 mm.

According to yet another aspect of the first tread, the perforations of the first rib have an axial width between 0.5 mm and 1.5 mm.

According to still another aspect of the first tread, the columns of perforations of the first rib have an axial spacing, perforation axial edge to adjacent perforation axial edge, ranging from 2.0 mm to 8.0 mm, or 3.0 mm to 5.0 mm.

According to yet another aspect of the first tread, the perforations of the first rib have a circumferential length between 1.0 mm, and 5.0 mm, or 3.0 mm and 4.0 mm.

According to still another aspect of the first tread, the perforations of the first rib have a circumferential length between 1.0 mm, and 5.0 mm, or 1.5 mm and 2.5 mm.

According to yet another aspect of the first tread, the perforations of the first rib have a circumferential length between 1.0 mm, and 5.0 mm, or 0.9 mm and 1.2 mm.

A second tread for a tire in accordance with the present invention includes a first circumferential groove axially separating a circumferential first rib and a circumferential second rib and a second circumferential groove axially separating the second rib from and a circumferential third rib. A first outer surface of the first rib has a first pattern of circumferential columns of circumferential, double blind perforations extending linearly fully around the first outer surface of the first rib. A second outer surface of the second rib has a second pattern of circumferential columns of circumferential, double blind perforations extending linearly fully around the second outer surface of the second rib. A third outer surface of the third rib has a third pattern of circumferential columns of circumferential, double blind perforations extending linearly fully around the third outer surface of the third rib. The first pattern is different from the second pattern and the third pattern and the second pattern is different from the first pattern and the third pattern.

According to another aspect of the second tread, the first outer surface of the first rib has at least one circumferential column of circumferential, double blind perforations extending linearly fully around the first outer surface of the first rib, the second outer surface of the second rib has at least one circumferential column of circumferential, double blind perforations extending linearly fully around the second outer surface of the second rib, and the third outer surface of the third rib has at least one circumferential column of circumferential, double blind perforations extending linearly fully around the third outer surface of the third rib.

According to still another aspect of the second tread, the first outer surface has between 2 and 12 circumferential columns of circumferential, double blind perforations extending linearly fully around the first outer surface of the first rib, the second outer surface has between 12 and 24 circumferential columns of circumferential, double blind perforations extending linearly fully around the second outer surface of the second rib, and the third outer surface has between 2 and 12 circumferential columns of circumferential, double blind perforations extending linearly fully around the third outer surface of the third rib.

According to yet another aspect of the second tread, the perforations of the first, second and third ribs have a radial depth between 1.0 mm and 3.0 mm.

According to still another aspect of the second tread, the perforations of the first, second and third ribs have an axial width between 0.5 mm and 1.5 mm.

According to yet another aspect of the second tread, the columns of perforations of the first and third ribs have an axial spacing, perforation axial edge to adjacent perforation axial edge, ranging from 2.0 mm to 8.0 mm.

According to still another aspect of the second tread, the columns of perforations of the second rib have an axial spacing, perforation axial edge to adjacent perforation axial edge, ranging from 2.0 mm to 8.0 mm, or 1.0 mm to 3.0 mm.

According to yet another aspect of the second tread, the perforations of the first rib have a circumferential length between 1.0 mm, and 5.0 mm, or 3.0 mm and 4.0 mm.

According to still another aspect of the second tread, the perforations of the second rib have a circumferential length between 1.0 mm, and 5.0 mm, or 1.5 mm and 2.5 mm.

According to yet another aspect of the second tread, the perforations of the third rib have a circumferential length between 1.0 mm, and 5.0 mm, or 0.9 mm and 1.2 mm.

### BRIEF DESCRIPTION OF THE DRAWINGS

The present invention will be more clearly understood by the following description of some examples thereof, with reference to the accompanying drawings, in which:

FIG. 1 is a schematic orthogonal front view of a pneumatic tire having a first example tread in accordance with the present invention.

FIG. 2 is a schematic orthogonal detail view of the pneumatic tire and tread of FIG. 1.

FIG. 3 is a schematic orthogonal front view of a pneumatic tire having a second example tread in accordance with the present invention.

FIG. 4 is a schematic orthogonal detail view of the pneumatic tire and tread of FIG. 3.

FIG. 5 is a schematic orthogonal front view of a pneumatic tire having a third example tread in accordance with the present invention.

FIG. 6 is a schematic orthogonal detail view of the pneumatic tire and tread of FIG. 5.

FIG. 7 is a schematic orthogonal front view of a pneumatic tire having a fourth example tread in accordance with the present invention.

FIG. 8 is a schematic orthogonal detail view of the pneumatic tire and tread of FIG. 7.

### DESCRIPTION OF EXAMPLES OF THE PRESENT INVENTION

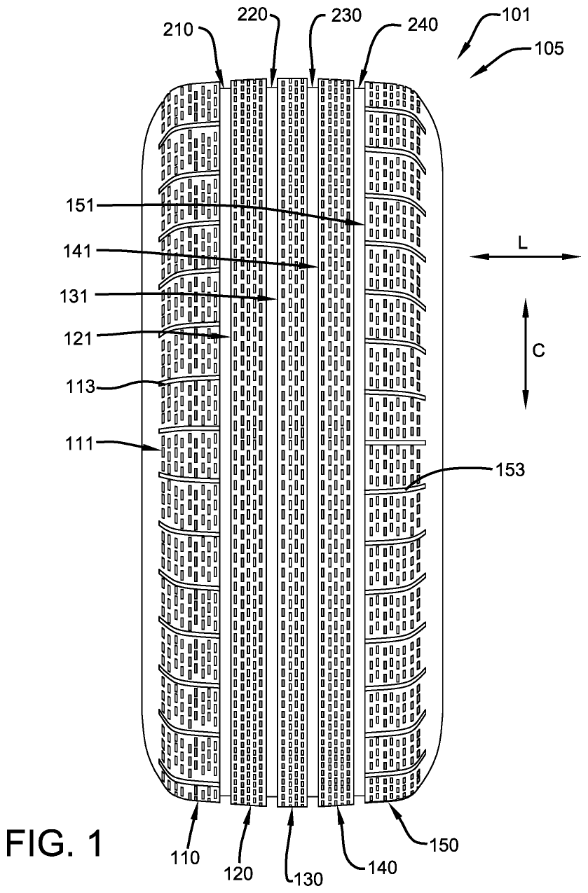

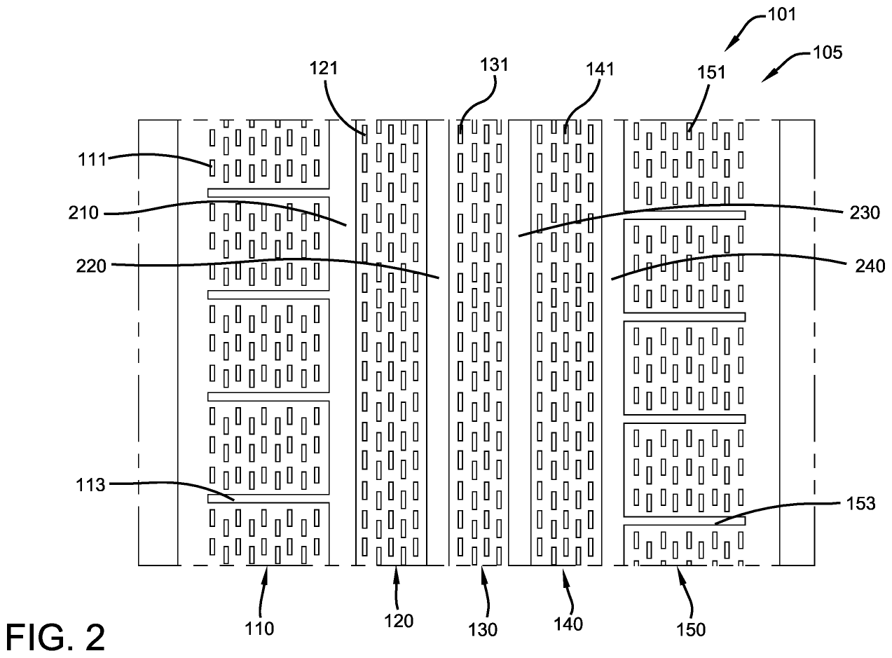

As shown in FIGS. 1-2, a pneumatic tire 101 in accordance with a first example of the present invention may include a tread 105 with a first main circumferential groove 210, a second main circumferential groove 220, a third main circumferential groove 230, and a fourth main circumferential groove 240 all extending in a circumferential direction C of the pneumatic tire 101 forming the tread 105. Five land portions, or ribs 110, 120, 130, 140, 150 may be formed by these main circumferential grooves 210, 220, 230, 240. Each of the first and fifth ribs 110, 150 may have additional lateral grooves 113, 153 extending laterally L across the ribs 110, 150 forming discreet and circumferentially repeating blocks, or tread elements. The main circumferential grooves 210, 220, 230, 240 may have, for example, a lateral width between 3.0 mm and 20.0 mm and an example radial depth between 5.0 mm and 13.0 mm.

The first shoulder rib 110 may further have a plurality of circumferential, double blind perforations 111, or “dashes”, extending linearly fully around the circumference of the first rib. These perforations 111 may (not shown) or may not (FIGS. 1-2) continue circumferentially through each of the lateral grooves 113. The number of columns of perforations 111 may range from 2 to 6, or 2 to 12. The perforations 111 may have depths ranging from 1.0 mm to 3.0 mm, or about 2.0 mm. The perforations 111 may have widths ranging from 0.5 mm to 1.5 mm. The perforations 111 may have a lateral spacing, perforation lateral edge to adjacent perforation lateral edge, ranging from 2.0 mm to 8.0 mm, or 3.0 mm to 5.0 mm. Each perforation 111 may have a circumferential length between 1.0 mm, and 5.0 mm, or 3.0 mm and 4.0 mm. The perforations 111 may have a circumferential spacing, perforation end to adjacent perforation end, ranging from 3.0 mm to 5.0 mm.

The columns of perforations 111 may be arranged such that the perforations of each column are circumferentially offset from the perforations of the adjacent columns (FIGS. 1-2). The depth, width, lateral spacing, and circumferential spacing of the perforations 111 may all effect the amount of ambient noise mitigation produced by the perforations. Generally, 2.0 mm may be an optimal depth and a greater density of perforations 111 may decrease noise more than a lesser density of perforations.

The second shoulder rib 120 may further have a plurality of circumferential, double blind perforations 121, or “dashes”, extending linearly fully around the circumference of the second rib. The number of columns of perforations 121 may range from 2 to 6, or 2 to 12. The perforations 121 may have depths ranging from 1.0 mm to 3.0 mm, or about 2.0 mm. The perforations 121 may have widths ranging from 0.5 mm to 1.5 mm. The perforations 121 may have a lateral spacing, perforation lateral edge to adjacent perforation lateral edge, ranging from 2.0 mm to 8.0 mm, or 3.0 mm to 5.0 mm. Each perforation 121 may have a circumferential length between 1.0 mm, and 5.0 mm, or 3.0 mm and 4.0 mm. The perforations 121 may have a circumferential spacing, perforation end to adjacent perforation end, ranging from 3.0 mm to 5.0 mm.

The columns of perforations 121 may be arranged such that the perforations of each column are circumferentially offset from the perforations of the adjacent columns (FIGS. 1-2). The depth, width, lateral spacing, and circumferential spacing of the perforations 121 may all effect the amount of ambient noise mitigation produced by the perforations. Generally, 2.0 mm may be an optimal depth and a greater density of perforations 121 may decrease noise more than a lesser density of perforations.

The third shoulder rib 130 may further have a plurality of circumferential, double blind perforations 131, or “dashes”, extending linearly fully around the circumference of the third rib. The number of columns of perforations 131 may range from 2 to 6, or 2 to 12. The perforations 131 may have depths ranging from 1.0 mm to 3.0 mm, or about 2.0 mm. The perforations 131 may have widths ranging from 0.5 mm to 1.5 mm. The perforations 131 may have a lateral spacing, perforation lateral edge to adjacent perforation lateral edge, ranging from 2.0 mm to 8.0 mm, or 3.0 mm to 5.0 mm. Each perforation 131 may have a circumferential length between 1.0 mm, and 5.0 mm, or 3.0 mm and 4.0 mm. The perforations 121 may have a circumferential spacing, perforation end to adjacent perforation end, ranging from 3.0 mm to 5.0 mm.

The columns of perforations 131 may be arranged such that the perforations of each column are circumferentially offset from the perforations of the adjacent columns (FIGS. 1-2). The depth, width, lateral spacing, and circumferential spacing of the perforations 131 may all effect the amount of ambient noise mitigation produced by the perforations. Generally, 2.0 mm may be an optimal depth and a greater density of perforations 131 may decrease noise more than a lesser density of perforations.

The fourth shoulder rib 140 may further have a plurality of circumferential, double blind perforations 141, or “dashes”, extending linearly fully around the circumference of the fourth rib. The number of columns of perforations 141 may range from 2 to 6, or 2 to 12. The perforations 141 may have depths ranging from 1.0 mm to 3.0 mm, or about 2.0 mm. The perforations 141 may have widths ranging from 0.5 mm to 1.5 mm. The perforations 141 may have a lateral spacing, perforation lateral edge to adjacent perforation lateral edge, ranging from 2.0 mm to 8.0 mm, or 3.0 mm to 5.0 mm. Each perforation 141 may have a circumferential length between 1.0 mm, and 5.0 mm, or 3.0 mm and 4.0 mm. The perforations 141 may have a circumferential spacing, perforation end to adjacent perforation end, ranging from 3.0 mm to 5.0 mm.

The columns of perforations 141 may be arranged such that the perforations of each column are circumferentially offset from the perforations of the adjacent columns (FIGS. 1-2). The depth, width, lateral spacing, and circumferential spacing of the perforations 141 may all effect the amount of ambient noise mitigation produced by the perforations. Generally, 2.0 mm may be an optimal depth and a greater density of perforations 141 may decrease noise more than a lesser density of perforations.

The fifth shoulder rib 150 may further have a plurality of circumferential, double blind perforations 151, or “dashes”, extending linearly fully around the circumference of the fifth rib. These perforations 151 may (not shown) or may not (FIGS. 1-2) continue circumferentially through each of the lateral grooves 153. The number of columns of perforations 151 may range from 2 to 6, or 2 to 12. The perforations 151 may have depths ranging from 1.0 mm to 3.0 mm, or about 2.0 mm. The perforations 151 may have widths ranging from 0.5 mm to 1.5 mm. The perforations 151 may have a lateral spacing, perforation lateral edge to adjacent perforation lateral edge, ranging from 2.0 mm to 8.0 mm, or 3.0 mm to 5.0 mm. Each perforation 151 may have a circumferential length between 1.0 mm, and 5.0 mm, or 3.0 mm and 4.0 mm. The perforations 151 may have a circumferential spacing, perforation end to adjacent perforation end, ranging from 3.0 mm to 5.0 mm.

The columns of perforations 151 may be arranged such that the perforations of each column are circumferentially offset from the perforations of the adjacent columns (FIGS. 1-2). The depth, width, lateral spacing, and circumferential spacing of the perforations 151 may all effect the amount of ambient noise mitigation produced by the perforations. Generally, 2.0 mm may be an optimal depth and a greater density of perforations 151 may decrease noise more than a lesser density of perforations.

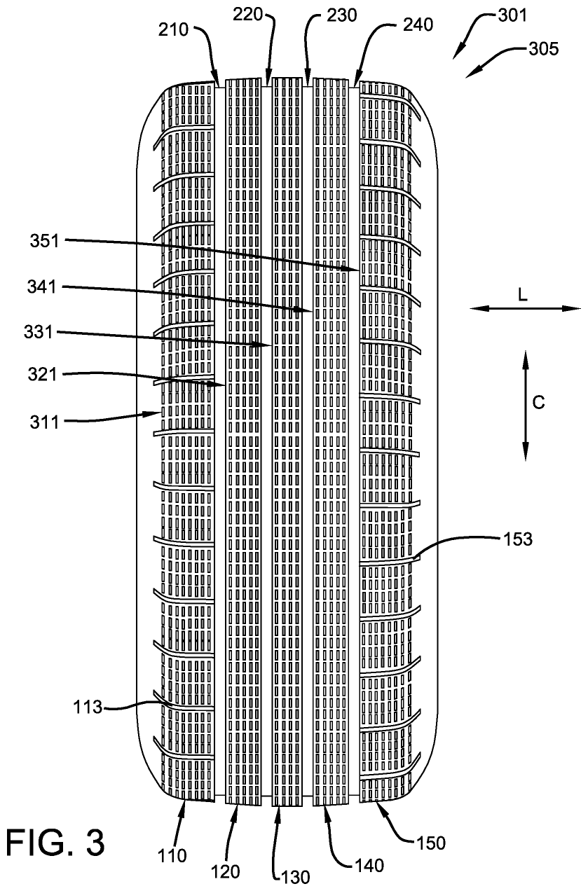

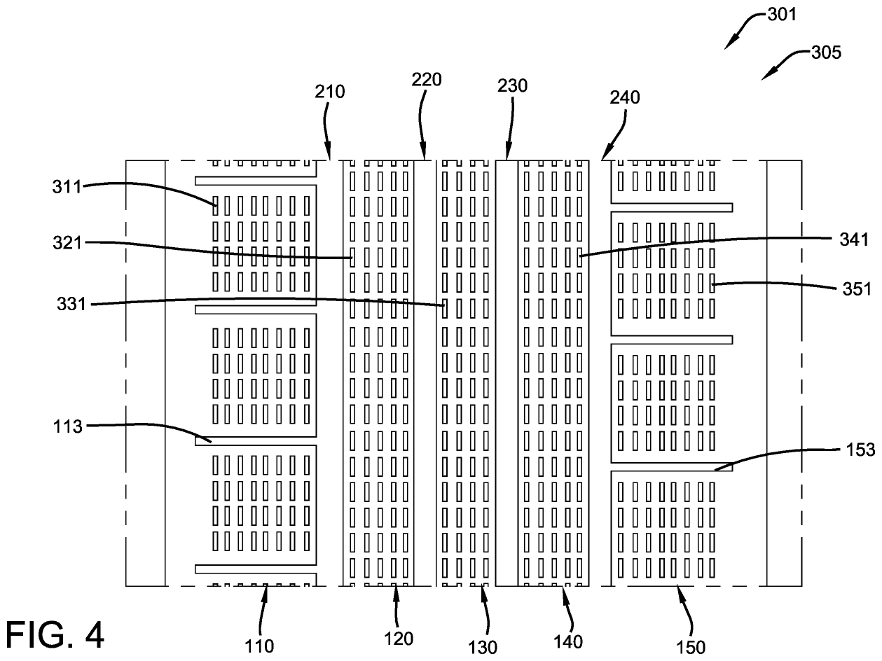

As shown in FIGS. 3-4, a pneumatic tire 301 in accordance with a second example of the present invention may include a tread 305 with a first main circumferential groove 210, a second main circumferential groove 220, a third main circumferential groove 230, and a fourth main circumferential groove 240 all extending in a circumferential direction C of the pneumatic tire 301 forming the tread 305. Like structures from FIG. 1-2 are given the same indicia. Five land portions, or ribs 110, 120, 130, 140, 150 may be formed by these main circumferential grooves 210, 220, 230, 240. Each of the first and fifth ribs 110, 150 may have additional lateral grooves 113, 153 extending laterally L across the ribs 110, 150 forming discreet and circumferentially repeating blocks, or tread elements. The main circumferential grooves 210, 220, 230, 240 may have, for example, a lateral width between 3.0 mm and 20.0 mm and an example radial depth between 5.0 mm and 13.0 mm.

The first shoulder rib 110 may further have a plurality of circumferential, double blind perforations 311, or “dashes”, extending linearly fully around the circumference of the first rib. The number of columns of perforations 311 may range from 2 to 6, or 2 to 12. The perforations 311 may have depths ranging from 1.0 mm to 3.0 mm, or about 2.0 mm. The perforations 311 may have widths ranging from 2.0 mm to 8.0 mm, or 0.5 mm to 1.5 mm. The perforations 311 may have a lateral spacing, perforation lateral edge to adjacent perforation lateral edge, ranging from 3.0 mm to 5.0 mm. Each perforation 311 may have a circumferential length between 1.0 mm, and 5.0 mm, or 1.5 mm and 2.5 mm. The perforations 311 may have a circumferential spacing, perforation end to adjacent perforation end, ranging from 3.0 mm to 5.0 mm.

The columns of perforations 311 may be arranged such that the perforations of each column are circumferentially aligned with the perforations of the adjacent columns (FIGS. 3-4). The depth, width, lateral spacing, and circumferential spacing of the perforations 311 may all effect the amount of ambient noise mitigation produced by the perforations. Generally, 2.0 mm may be an optimal depth and a greater density of perforations 311 may decrease noise more than a lesser density of perforations.

The second shoulder rib 120 may further have a plurality of circumferential, double blind perforations 321, or “dashes”, extending linearly fully around the circumference of the second rib. The number of columns of perforations 321 may range from 2 to 6, or 2 to 12. The perforations 321 may have depths ranging from 1.0 mm to 3.0 mm, or about 2.0 mm. The perforations 321 may have widths ranging from 0.5 mm to 1.5 mm. The perforations 321 may have a lateral spacing, perforation lateral edge to adjacent perforation lateral edge, ranging from 2.0 mm to 8.0 mm, or 3.0 mm to 5.0 mm. Each perforation 321 may have a circumferential length between 1.0 mm, and 5.0 mm, or 1.5 mm and 2.5 mm. The perforations 321 may have a circumferential spacing, perforation end to adjacent perforation end, ranging from 3.0 mm to 5.0 mm.

The columns of perforations 321 may be arranged such that the perforations of each column are circumferentially aligned with the perforations of the adjacent columns (FIGS. 3-4). The depth, width, lateral spacing, and circumferential spacing of the perforations 321 may all effect the amount of ambient noise mitigation produced by the perforations. Generally, 2.0 mm may be an optimal depth and a greater density of perforations 321 may decrease noise more than a lesser density of perforations.

The third shoulder rib 130 may further have a plurality of circumferential, double blind perforations 331, or “dashes”, extending linearly fully around the circumference of the third rib. The number of columns of perforations 331 may range from 2 to 6, or 2 to 12. The perforations 331 may have depths ranging from 1.0 mm to 3.0 mm, or about 2.0 mm. The perforations 331 may have widths ranging from 0.5 mm to 1.5 mm. The perforations 331 may have a lateral spacing, perforation lateral edge to adjacent perforation lateral edge, ranging from 2.0 mm to 8.0 mm, or 3.0 mm to 5.0 mm. Each perforation 331 may have a circumferential length between 1.0 mm, and 5.0 mm, or 1.5 mm and 2.5 mm. The perforations 321 may have a circumferential spacing, perforation end to adjacent perforation end, ranging from 3.0 mm to 5.0 mm.

The columns of perforations 331 may be arranged such that the perforations of each column are circumferentially aligned with the perforations of the adjacent columns (FIGS. 3-4). The depth, width, lateral spacing, and circumferential spacing of the perforations 331 may all effect the amount of ambient noise mitigation produced by the perforations. Generally, 2.0 mm may be an optimal depth and a greater density of perforations 331 may decrease noise more than a lesser density of perforations.

The fourth shoulder rib 140 may further have a plurality of circumferential, double blind perforations 341, or “dashes”, extending linearly fully around the circumference of the fourth rib. The number of columns of perforations 341 may range from 2 to 6, or 2 to 12. The perforations 341 may have depths ranging from 1.0 mm to 3.0 mm, or about 2.0 mm. The perforations 341 may have widths ranging from 0.5 mm to 1.5 mm. The perforations 341 may have a lateral spacing, perforation lateral edge to adjacent perforation lateral edge, ranging from 2.0 mm to 8.0 mm, or 3.0 mm to 5.0 mm. Each perforation 341 may have a circumferential length between 1.0 mm, and 5.0 mm, or 1.5 mm and 2.5 mm. The perforations 341 may have a circumferential spacing, perforation end to adjacent perforation end, ranging from 3.0 mm to 5.0 mm.

The columns of perforations 341 may be arranged such that the perforations of each column are circumferentially aligned with the perforations of the adjacent columns (FIGS. 3-4). The depth, width, lateral spacing, and circumferential spacing of the perforations 341 may all effect the amount of ambient noise mitigation produced by the perforations. Generally, 2.0 mm may be an optimal depth and a greater density of perforations 341 may decrease noise more than a lesser density of perforations.

The fifth shoulder rib 150 may further have a plurality of circumferential, double blind perforations 351, or “dashes”, extending linearly fully around the circumference of the fifth rib. These perforations 351 may (not shown) or may not (FIGS. 3-4) continue circumferentially through each of the lateral grooves 153. The number of columns of perforations 351 may range from 2 to 6, or 2 to 12. The perforations 351 may have depths ranging from 1.0 mm to 3.0 mm, or about 2.0 mm. The perforations 151 may have widths ranging from 0.5 mm to 1.5 mm. The perforations 351 may have a lateral spacing, perforation lateral edge to adjacent perforation lateral edge, ranging from 2.0 mm to 8.0 mm, or 3.0 mm to 5.0 mm. Each perforation 351 may have a circumferential length between 1.5 mm and 2.5 mm. The perforations 351 may have a circumferential spacing, perforation end to adjacent perforation end, ranging from 3.0 mm to 5.0 mm.

The columns of perforations 351 may be arranged such that the perforations of each column are circumferentially aligned with the perforations of the adjacent columns (FIGS. 3-4). The depth, width, lateral spacing, and circumferential spacing of the perforations 351 may all effect the amount of ambient noise mitigation produced by the perforations. Generally, 2.0 mm may be an optimal depth and a greater density of perforations 351 may decrease noise more than a lesser density of perforations.

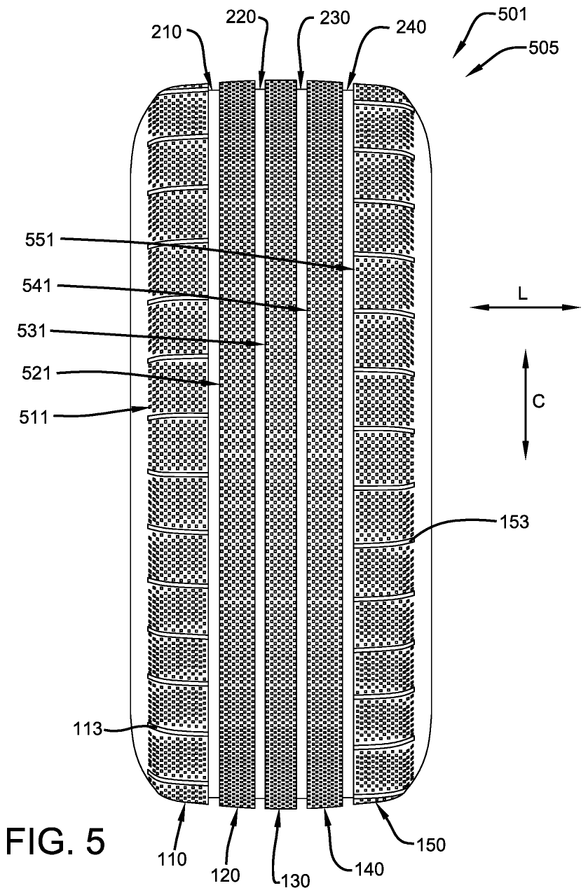

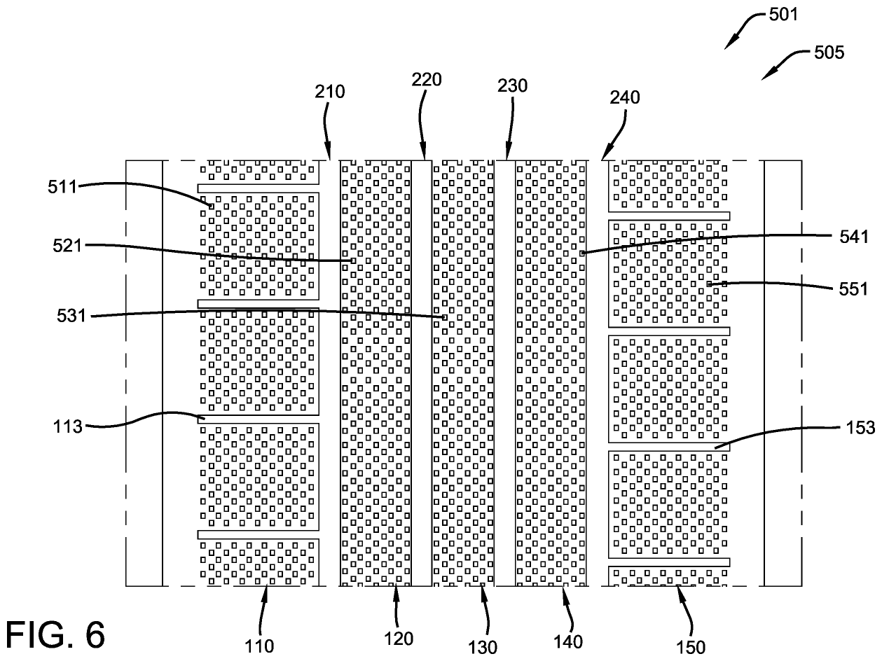

As shown in FIGS. 5-6, a pneumatic tire 501 in accordance with a third example of the present invention may include a tread 505 with a first main circumferential groove 210, a second main circumferential groove 220, a third main circumferential groove 230, and a fourth main circumferential groove 240 all extending in a circumferential direction C of the pneumatic tire 301 forming the tread 305. Like structures from FIG. 1-2 are given the same indicia. Five land portions, or ribs 110, 120, 130, 140, 150 may be formed by these main circumferential grooves 210, 220, 230, 240. Each of the first and fifth ribs 110, 150 may have additional lateral grooves 113, 153 extending laterally L across the ribs 110, 150 forming discreet and circumferentially repeating blocks, or tread elements. The main circumferential grooves 210, 220, 230, 240 may have, for example, a lateral width between 3.0 mm and 20.0 mm and an example radial depth between 5.0 mm and 13.0 mm.

The first shoulder rib 110 may further have a plurality of circumferential, double blind perforations 511, or “dashes”, extending linearly fully around the circumference of the first rib. These perforations 511 may (not shown) or may not (FIGS. 5-6) continue circumferentially through each of the lateral grooves 113. The number of columns of perforations 511 may range from 2 to 6, or 12 to 24. The perforations 511 may have depths ranging from 1.0 mm to 3.0 mm, or about 2.0 mm. The perforations 511 may have widths ranging from 0.5 mm to 1.5 mm. The perforations 511 may have a lateral spacing, perforation lateral edge to adjacent perforation lateral edge, ranging from 2.0 mm to 8.0 mm, or 1.0 mm to 3.0 mm. Each perforation 511 may have a circumferential length between 0.8 mm, and 5.0 mm, or 0.9 mm and 1.2 mm. The perforations 511 may have a circumferential spacing, perforation end to adjacent perforation end, ranging from 1.0 mm to 3.0 mm.

The columns of perforations 511 may be arranged such that the perforations of each column are circumferentially offset from the perforations of the adjacent columns (FIGS. 5-6). The depth, width, lateral spacing, and circumferential spacing of the perforations 511 may all effect the amount of ambient noise mitigation produced by the perforations. Generally, 2.0 mm may be an optimal depth and a greater density of perforations 511 may decrease noise more than a lesser density of perforations.

The second shoulder rib 120 may further have a plurality of circumferential, double blind perforations 521, or “dashes”, extending linearly fully around the circumference of the second rib. The number of columns of perforations 521 may range from 2 to 6, or 12 to 24. The perforations 521 may have depths ranging from 1.0 mm to 3.0 mm, or about 2.0 mm. The perforations 521 may have widths ranging from 0.5 mm to 1.5 mm. The perforations 521 may have a lateral spacing, perforation lateral edge to adjacent perforation lateral edge, ranging from 2.0 mm to 8.0 mm, or 1.0 mm to 3.0 mm. Each perforation 521 may have a circumferential length between 0.8 mm, and 5.0 mm, or 0.9 mm and 1.2 mm. The perforations 521 may have a circumferential spacing, perforation end to adjacent perforation end, ranging from 1.0 mm to 3.0 mm.

The columns of perforations 521 may be arranged such that the perforations of each column are circumferentially offset from with the perforations of the adjacent columns (FIGS. 5-6). The depth, width, lateral spacing, and circumferential spacing of the perforations 521 may all effect the amount of ambient noise mitigation produced by the perforations. Generally, 2.0 mm may be an optimal depth and a greater density of perforations 521 may decrease noise more than a lesser density of perforations.

The third shoulder rib 130 may further have a plurality of circumferential, double blind perforations 531, or “dashes”, extending linearly fully around the circumference of the third rib. The number of columns of perforations 531 may range from 2 to 6, or 12 to 24. The perforations 531 may have depths ranging from 1.0 mm to 3.0 mm, or about 2.0 mm. The perforations 531 may have widths ranging from 0.5 mm to 1.5 mm. The perforations 531 may have a lateral spacing, perforation lateral edge to adjacent perforation lateral edge, ranging from 2.0 mm to 8.0 mm, or 1.0 mm to 3.0 mm. Each perforation 531 may have a circumferential length between 0.8 mm, and 5.0 mm, or 0.9 mm and 1.2 mm. The perforations 521 may have a circumferential spacing, perforation end to adjacent perforation end, ranging from 1.0 mm to 3.0 mm.

The columns of perforations 531 may be arranged such that the perforations of each column are circumferentially offset from the perforations of the adjacent columns (FIGS. 5-6). The depth, width, lateral spacing, and circumferential spacing of the perforations 531 may all effect the amount of ambient noise mitigation produced by the perforations. Generally, 2.0 mm may be an optimal depth and a greater density of perforations 531 may decrease noise more than a lesser density of perforations.

The fourth shoulder rib 140 may further have a plurality of circumferential, double blind perforations 541, or “dashes”, extending linearly fully around the circumference of the fourth rib. The number of columns of perforations 541 may range from 2 to 6, or 12 to 24. The perforations 541 may have depths ranging from 1.0 mm to 3.0 mm, or about 2.0 mm. The perforations 541 may have widths ranging from 0.5 mm to 1.5 mm. The perforations 541 may have a lateral spacing, perforation lateral edge to adjacent perforation lateral edge, ranging from 2.0 mm to 8.0 mm, or 1.0 mm to 3.0 mm. Each perforation 541 may have a circumferential length between 0.8 mm, and 5.0 mm, or 0.9 mm and 1.2 mm. The perforations 541 may have a circumferential spacing, perforation end to adjacent perforation end, ranging from 1.0 mm to 3.0 mm.

The columns of perforations 541 may be arranged such that the perforations of each column are circumferentially offset from with the perforations of the adjacent columns (FIGS. 5-6). The depth, width, lateral spacing, and circumferential spacing of the perforations 541 may all effect the amount of ambient noise mitigation produced by the perforations. Generally, 2.0 mm may be an optimal depth and a greater density of perforations 541 may decrease noise more than a lesser density of perforations.

The fifth shoulder rib 150 may further have a plurality of circumferential, double blind perforations 551, or “dashes”, extending linearly fully around the circumference of the fifth rib. These perforations 551 may (not shown) or may not (FIGS. 5-6) continue circumferentially through each of the lateral grooves 153. The number of columns of perforations 551 may range from 2 to 6, or 12 to 24. The perforations 551 may have depths ranging from 1.0 mm to 3.0 mm, or about 2.0 mm. The perforations 551 may have widths ranging from 0.5 mm to 1.5 mm. The perforations 551 may have a lateral spacing, perforation lateral edge to adjacent perforation lateral edge, ranging from 2.0 mm to 8.0 mm, or 1.0 mm to 3.0 mm. Each perforation 551 may have a circumferential length between 0.8 mm, and 5.0 mm, or 0.9 mm and 1.2 mm. The perforations 551 may have a circumferential spacing, perforation end to adjacent perforation end, ranging from 1.0 mm to 3.0 mm.

The columns of perforations 551 may be arranged such that the perforations of each column are circumferentially offset from the perforations of the adjacent columns (FIGS. 5-6). The depth, width, lateral spacing, and circumferential spacing of the perforations 551 may all effect the amount of ambient noise mitigation produced by the perforations. Generally, 2.0 mm may be an optimal depth and a greater density of perforations 551 may decrease noise more than a lesser density of perforations.

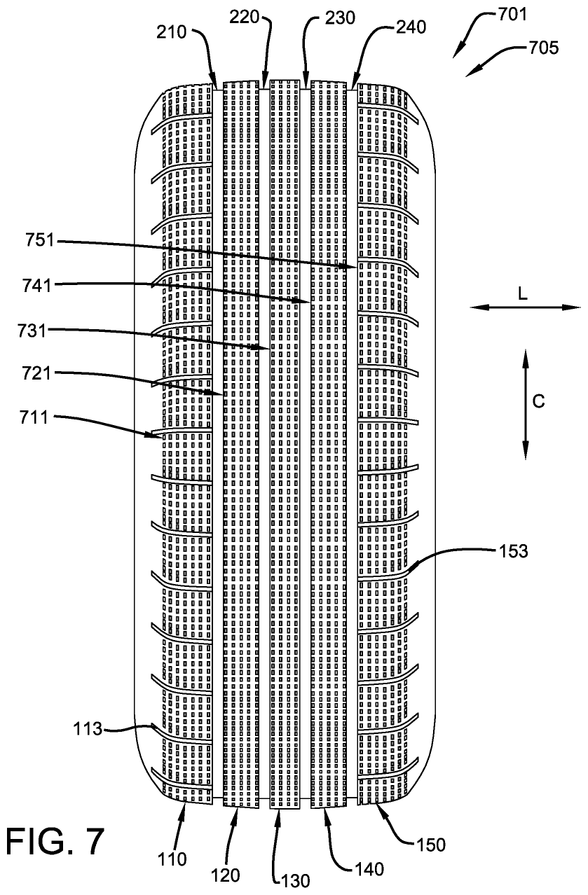

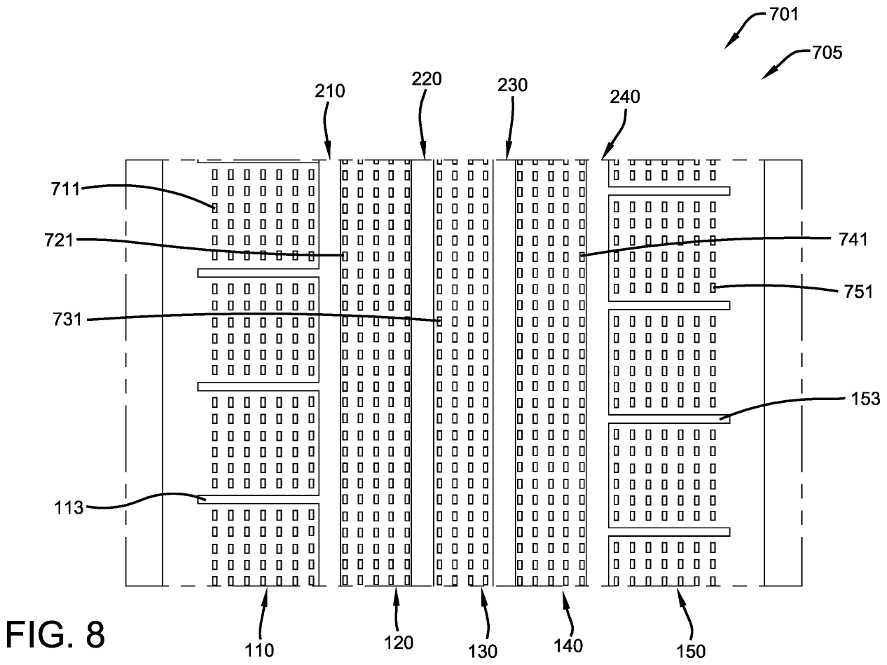

As shown in FIGS. 7-8, a pneumatic tire 701 in accordance with a second example of the present invention may include a tread 705 with a first main circumferential groove 210, a second main circumferential groove 220, a third main circumferential groove 230, and a fourth main circumferential groove 240 all extending in a circumferential direction C of the pneumatic tire 301 forming the tread 305. Like structures from FIG. 1-2 are given the same indicia. Five land portions, or ribs 110, 120, 130, 140, 150 may be formed by these main circumferential grooves 210, 220, 230, 240. Each of the first and fifth ribs 110, 150 may have additional lateral grooves 113, 153 extending laterally L across the ribs 110, 150 forming discreet and circumferentially repeating blocks, or tread elements. The main circumferential grooves 210, 220, 230, 240 may have, for example, a lateral width between 3.0 mm and 20.0 mm and an example radial depth between 5.0 mm and 13.0 mm.

The first shoulder rib 110 may further have a plurality of circumferential, double blind perforations 711, or “dashes”, extending linearly fully around the circumference of the first rib. These perforations 711 may (not shown) or may not (FIGS. 7-8) continue circumferentially through each of the lateral grooves 113. The number of columns of perforations 711 may range from 2 to 6, or 12 to 24. The perforations 711 may have depths ranging from 1.0 mm to 3.0 mm, or about 2.0 mm. The perforations 711 may have widths ranging from 0.5 mm to 1.5 mm. The perforations 711 may have a lateral spacing, perforation lateral edge to adjacent perforation lateral edge, ranging from 2.0 mm to 8.0 mm, or 1.0 mm to 3.0 mm. Each perforation 711 may have a circumferential length between 1.0 mm, and 5.0 mm, or 1.5 mm and 2.5 mm. The perforations 711 may have a circumferential spacing, perforation end to adjacent perforation end, ranging from 1.0 mm to 3.0 mm.

The columns of perforations 711 may be arranged such that the perforations of each column are circumferentially aligned with the perforations of the adjacent columns (FIGS. 7-8). The depth, width, lateral spacing, and circumferential spacing of the perforations 711 may all effect the amount of ambient noise mitigation produced by the perforations. Generally, 2.0 mm may be an optimal depth and a greater density of perforations 711 may decrease noise more than a lesser density of perforations.

The second shoulder rib 120 may further have a plurality of circumferential, double blind perforations 721, or “dashes”, extending linearly fully around the circumference of the second rib. The number of columns of perforations 721 may range from 2 to 6, or 12 to 24. The perforations 721 may have depths ranging from 1.0 mm to 3.0 mm, or about 2.0 mm. The perforations 721 may have widths ranging from 0.5 mm to 1.5 mm. The perforations 721 may have a lateral spacing, perforation lateral edge to adjacent perforation lateral edge, ranging from 2.0 mm to 8.0 mm, or 1.0 mm to 3.0 mm. Each perforation 721 may have a circumferential length between 1.0 mm, and 5.0 mm, or 1.5 mm and 2.5 mm. The perforations 721 may have a circumferential spacing, perforation end to adjacent perforation end, ranging from 1.0 mm to 3.0 mm.

The columns of perforations 721 may be arranged such that the perforations of each column are circumferentially aligned with the perforations of the adjacent columns (FIGS. 7-8). The depth, width, lateral spacing, and circumferential spacing of the perforations 721 may all effect the amount of ambient noise mitigation produced by the perforations. Generally, 2.0 mm may be an optimal depth and a greater density of perforations 721 may decrease noise more than a lesser density of perforations.

The third shoulder rib 130 may further have a plurality of circumferential, double blind perforations 731, or “dashes”, extending linearly fully around the circumference of the third rib. The number of columns of perforations 731 may range from 2 to 6, or 12 to 24. The perforations 731 may have depths ranging from 1.0 mm to 3.0 mm, or about 2.0 mm. The perforations 731 may have widths ranging from 0.5 mm to 1.5 mm. The perforations 731 may have a lateral spacing, perforation lateral edge to adjacent perforation lateral edge, ranging from 2.0 mm to 8.0 mm, or 1.0 mm to 3.0 mm. Each perforation 731 may have a circumferential length between 1.0 mm, and 5.0 mm, or 1.5 mm and 2.5 mm. The perforations 721 may have a circumferential spacing, perforation end to adjacent perforation end, ranging from 1.0 mm to 3.0 mm.

The columns of perforations 731 may be arranged such that the perforations of each column are circumferentially aligned with the perforations of the adjacent columns (FIGS. 7-8). The depth, width, lateral spacing, and circumferential spacing of the perforations 731 may all effect the amount of ambient noise mitigation produced by the perforations. Generally, 2.0 mm may be an optimal depth and a greater density of perforations 731 may decrease noise more than a lesser density of perforations.

The fourth shoulder rib 140 may further have a plurality of circumferential, double blind perforations 741, or “dashes”, extending linearly fully around the circumference of the fourth rib. The number of columns of perforations 741 may range from 2 to 6, or 12 to 24. The perforations 741 may have depths ranging from 1.0 mm to 3.0 mm, or about 2.0 mm. The perforations 741 may have widths ranging from 0.5 mm to 1.5 mm. The perforations 741 may have a lateral spacing, perforation lateral edge to adjacent perforation lateral edge, ranging from 2.0 mm to 8.0 mm, or 1.0 mm to 3.0 mm. Each perforation 741 may have a circumferential length between 1.0 mm, and 5.0 mm, or 1.5 mm and 2.5 mm. The perforations 741 may have a circumferential spacing, perforation end to adjacent perforation end, ranging from 1.0 mm to 3.0 mm.

The columns of perforations 741 may be arranged such that the perforations of each column are circumferentially aligned with the perforations of the adjacent columns (FIGS. 7-8). The depth, width, lateral spacing, and circumferential spacing of the perforations 741 may all effect the amount of ambient noise mitigation produced by the perforations. Generally, 2.0 mm may be an optimal depth and a greater density of perforations 741 may decrease noise more than a lesser density of perforations.

The fifth shoulder rib 150 may further have a plurality of circumferential, double blind perforations 751, or “dashes”, extending linearly fully around the circumference of the fifth rib. These perforations 751 may (not shown) or may not (FIGS. 3-4) continue circumferentially through each of the lateral grooves 153. The number of columns of perforations 751 may range from 2 to 6, or 12 to 24. The perforations 751 may have depths ranging from 1.0 mm to 3.0 mm, or about 2.0 mm. The perforations 751 may have widths ranging from 0.5 mm to 1.5 mm. The perforations 751 may have a lateral spacing, perforation lateral edge to adjacent perforation lateral edge, ranging from 2.0 mm to 8.0 mm, or 1.0 mm to 3.0 mm. Each perforation 751 may have a circumferential length between 1.0 mm, and 5.0 mm, or 1.5 mm and 2.5 mm. The perforations 751 may have a circumferential spacing, perforation end to adjacent perforation end, ranging from 1.0 mm to 3.0 mm.

The columns of perforations 751 may be arranged such that the perforations of each column are circumferentially aligned with the perforations of the adjacent columns (FIGS. 7-8). The depth, width, lateral spacing, and circumferential spacing of the perforations 751 may all effect the amount of ambient noise mitigation produced by the perforations. Generally, 2.0 mm may be an optimal depth and a greater density of perforations 751 may decrease noise more than a lesser density of perforations.

The ribs 110, 120, 130, 140, 150 of a single tread 105, 305, 505, or 705 may have any combination of perforation patterns and dimensions, as described in FIGS. 1-2, FIGS. 3-4, FIGS. 5-6, and/or FIGS. 7-8. This may further tune the noise mitigation characteristics of such a single tread. For example, a first pattern/dimension of the first rib 110 may be different from a second pattern/dimension of the second rib 120 and a third pattern/dimension of the third rib 130 and the second pattern/dimension may be different from the first pattern/dimension and the third pattern/dimension with the first pattern/dimension being the same as a fifth pattern/dimension of the fifth rib 150 and the second pattern/dimension being the same as a fourth pattern/dimension of the fourth rib 140.

While the present invention has been described in connection with what is considered the most practical example, it is to be understood that the present invention is not to be limited to the disclosed arrangements, but is intended to cover various arrangements which are included within the spirit and scope of the broadest possible interpretation of the appended claims so as to encompass all possible modifications and equivalent arrangements.

What is claimed:

1. A tread for a tire comprising:
a first circumferential groove axially separating a circumferential first rib and a second circumferential rib, a first outer surface of the first rib having at least one circumferential column of circumferential, double blind perforations extending linearly fully around the first outer surface of the first rib.

2. The tread as set forth in claim 1 wherein a second outer surface of the second rib has at least one circumferential column of circumferential, double blind perforations extending linearly fully around the second outer surface of the second rib.

3. The tread as set forth in claim 2 wherein the first outer surface has between 2 and 6 circumferential columns of circumferential, double blind perforations extending linearly fully around the first outer surface of the first rib.

4. The tread as set forth in claim 3 wherein the second outer surface has between 2 and 6 circumferential columns of circumferential, double blind perforations extending linearly fully around the second outer surface of the second rib.

5. The tread as set forth in claim 4 wherein the perforations of the first rib have a radial depth between 1.0 mm and 3.0 mm.

6. The tread as set forth in claim 5 wherein the perforations of the first rib have an axial width between 0.5 mm and 1.5 mm.

7. The tread as set forth in claim 6 wherein the columns of perforations of the first rib have an axial spacing, perforation axial edge to adjacent perforation axial edge, ranging from 2.0 mm to 8.0 mm.

8. The tread as set forth in claim 7 wherein the perforations of the first rib have a circumferential length between 3.0 mm and 4.0 mm.

9. The tread as set forth in claim 7 wherein the perforations of the first rib have a circumferential length between 1.5 mm and 2.5 mm.

10. The tread as set forth in claim 7 wherein the perforations of the first rib have a circumferential length between 0.9 mm and 1.2 mm.

11. A tread for a tire comprising:
a first circumferential groove axially separating a circumferential first rib and a circumferential second rib and a second circumferential groove axially separating the second rib from and a circumferential third rib,
a first outer surface of the first rib having a first pattern of circumferential columns of circumferential, double blind perforations extending linearly fully around the first outer surface of the first rib.
a second outer surface of the second rib having a second pattern of circumferential columns of circumferential, double blind perforations extending linearly fully around the second outer surface of the second rib,
a third outer surface of the third rib having a third pattern of circumferential columns of circumferential, double blind perforations extending linearly fully around the third outer surface of the third rib,
the first pattern being different from the second pattern and the third pattern, the second pattern being different from the first pattern and the third pattern.

12. The tread as set forth in claim 11 wherein the first outer surface of the first rib has at least one circumferential column of circumferential, double blind perforations extending linearly fully around the first outer surface of the first rib, the second outer surface of the second rib has at least one circumferential column of circumferential, double blind perforations extending linearly fully around the second outer surface of the second rib, and the third outer surface of the third rib has at least one circumferential column of circumferential, double blind perforations extending linearly fully around the third outer surface of the third rib.

13. The tread as set forth in claim 12 wherein the first outer surface has between 2 and 12 circumferential columns of circumferential, double blind perforations extending linearly fully around the first outer surface of the first rib, the second outer surface has between 12 and 24 circumferential columns of circumferential, double blind perforations extending linearly fully around the second outer surface of the second rib, and the third outer surface has between 2 and 12 circumferential columns of circumferential, double blind perforations extending linearly fully around the third outer surface of the third rib.

14. The tread as set forth in claim 13 wherein the perforations of the first, second and third ribs have a radial depth between 1.0 mm and 3.0 mm.

15. The tread as set forth in claim 14 wherein the perforations of the first, second and third ribs have an axial width between 0.5 mm and 1.5 mm.

16. The tread as set forth in claim 15 wherein the columns of perforations of the first and third ribs have an axial spacing, perforation axial edge to adjacent perforation axial edge, ranging from 2.0 mm to 8.0 mm.

17. The tread as set forth in claim 16 wherein the columns of perforations of the second rib have an axial spacing, perforation axial edge to adjacent perforation axial edge, ranging from 2.0 mm to 8.0 mm.

18. The tread as set forth in claim 17 wherein the perforations of the first rib have a circumferential length between 3.0 mm and 4.0 mm.

19. The tread as set forth in claim 18 wherein the perforations of the second rib have a circumferential length between 1.5 mm and 2.5 mm.

20. The tread as set forth in claim 19 wherein the perforations of the third rib have a circumferential length between 0.9 mm and 1.2 mm.
